(19) United States
(12) Patent Application Publication
(10) Pub. No.: US 2019/0011151 A1
(43) Pub. Date: Jan. 10, 2019

(54) THROUGHFLOW HEATER

(71) Applicant: C3 CASTING COMPETENCE CENTER GMBH, Niederbüren (CH)

(72) Inventors: Manuela WAGNER, Niederbüren (CH); Walter WAGNER, Niederbüren (CH)

(21) Appl. No.: 16/066,605

(22) PCT Filed: Dec. 20, 2016
(86) PCT No.: PCT/EP2016/081949

§ 371 Date: Jun. 27, 2018

(30) Foreign Application Priority Data
Dec. 28, 2015 (CH) 01913/15

(51) Int. Cl. F24H 9/20; F24H 1/12; F24H 9/18

(52) U.S. Cl. CPC F24H 9/2028; A47J 31/542; F24H 9/1818; F24H 1/121

(57) ABSTRACT

A throughflow heater comprises an outer surface encircling a longitudinal axis, inwardly adjoining the outer surface a conveying region for a fluid that is to be heated, inwardly adjoining the conveying region at a transition surface a heating layer with an electrical heating element and heat-conducting material, and an insulating core which extends centrally along the longitudinal axis and outwardly forms a support surface for the electrical heating element and the heat-conducting material. The thermal conductivity of the insulating core is lower than that of the heat-conducting material. The radial extent of a channel arranged in the conveying region is less than 1 mm.

The invention relates to throughflow heaters with electric heating devices.

From DE 10 2009 024 059 A1, a throughflow heater with a cylindrical, electric heating device and an enveloping tube surrounding it at least partially at a distance is known. Liquid flows between the cylindrical heating device and the enveloping tube from an inlet to a drain and is thereby heated. The heating device comprises a cylindrical jacket tube and, inside the jacket tube, a coiled heating wire and magnesium oxide, wherein the magnesium oxide fills the entire interior of the jacket tube which is not occupied by the heating wire. The magnesium oxide absorbs heat generated by the heating wire and conducts it at least partially to the jacket tube. When this throughflow heater heats liquid from the cold state, it is first necessary to heat a large amount of magnesium oxide, resulting in sluggish operation that is undesirable in many applications.

An overheating protection device, in particular a fusible link, is mounted according to DE 10 2009 024 059 A1 on the outside of the enveloping tube, wherein the enveloping tube rests at this point on the jacket tube of the heating device, so that the overheating protection device measures the temperature of the jacket tube. The overheating protection device projecting radially outward from the enveloping tube requires space that is often not available for devices with limited space. In addition, it has been recognized that the overheating protection device is sometimes destroyed without the occurrence of an event that would have really made melting necessary for protection against dangerous overheating.

From WO 2013/189869 A1 a throughflow heater is known, which provides hot liquid starting from the cold state, wherein in this case a very high electrical power is then required, at least for a short time. In embodiments with a short reaction time, disruptive voltage discharges can occur from the heating wire to the electrically conducting enveloping tube. The throughflow heater is equipped on its outside with an overheating protection device, namely an EFEN fuse. The space requirement of the throughflow heater with overheating protection device is large. In addition, unnecessary protective tripping may occur.

The documents EP 2 543 936 A2, DE 689 15 124 T2, DE 601 00 257 T2, GB 2 098 436 A and WO 2010/060756 A1 show throughflow heaters which heat up only slowly. Another disadvantage is that the overheating protection device is arranged in the axial direction on the heating wire adjacent to at least one end face of a cylindrical heating device. As a result of this arrangement of the overheating protection device, the length of the heating device is already undesirably large due to the overheating protection device. Long cylindrical heating devices cannot be used in appliances with limited space or only with unwanted compromises with respect to other elements. The electrical connections at both face ends of the heating device require additional space in the appliance.

Even with configurations with the overheating protection device at one face end, the fusible link can be destroyed without an event that makes melting as a protection against dangerous overheating really necessary. In special situations, it is also possible that a necessary triggering of the overheating protection device does not take place.

The solution according to DE 34 33 688 A1 shows an overheating protection device in the central axial region of the cylindrical heating device between two areas, each with a heating wire. The insertion of the overheating protection device between two heating wires, the arrangement of the two heating wires with the overheating protection device in the jacket tube and the subsequent filling of the heat-conducting and electrically insulating material in the areas outside and inside the helically extending heating wires and around the overheating protection device are very expensive. In addition, the arrangement of the overheating protection device in the heating device undesirably increases the length of the heating device and the electrical connections on both ends of the heater restrict the use of this heating device.

It is now the object of the invention to find a fast-heating throughflow heater that can be easily manufactured and be used efficiently.

The object is achieved by the features of claim 1. The dependent claims describe alternative or advantageous embodiments, which solve further problems.

The throughflow heaters according to the invention are externally bordered by a jacket-shaped outer surface and two end faces. The outer surface encloses a longitudinal axis and the two end faces facing away from each other extend transversely to the longitudinal axis. A lead-through area for a fluid to be heated adjoins the outer surface on the inside. A transitional surface is located inside the lead-through area. A heating layer with an electric heating element and heat-conducting material adjoins the transition surface against the longitudinal axis. A carrier layer of a central insulating core adjoins the heating layer against the longitudinal axis. The thermal conductivity of the insulating core is smaller than that of the heat-conducting material. This ensures that the majority of the heat generated by the heating element is conducted away from the longitudinal axis to the outside to the lead-through area for the medium to be heated.

The throughflow heater comprises an inner sleeve, an outer sleeve and between the inner and the outer sleeve at least one channel which extends outwardly in a sealed manner between two connections and in a coiled manner around the longitudinal axis, and comprises in addition at least one coiled guide wall, extending from the outer surface against the transition surface and defining a rectangular channel cross-section with two long sides in the sleeves and two short, radially extending sides of the guide wall. In the context of the invention, it has been recognized that in the case of the cross-section of the coiled channel, the length of the short sides must be less than 1 mm, preferably in the range of 0.8 mm to 0.4 mm.

With this unexpectedly minimal short side or with the small radial extension of the channel, an extremely fast-heating throughflow heater can be provided, which does not require undesirably high electrical power peaks during operation. To find this solution, the prejudice had to be overcome that a sufficient outflow quantity of a heated liquid can be achieved only with a large receiving volume in the Throughflow heater and with channel cross-sections which allow through-flow even with lime deposits. With the extremely small radial extension of the channel according to the invention, the flow rate is increased, which substantially prevents the deposition of lime. The reduced dwell time of the liquid in the throughflow heater due to the higher flow rate is less detrimental to the rapid heating of the liquid than the inertia of heating a liquid in a channel with the large radial dimensions known from the prior art.

In addition to the small radial extension of the channel, the ratio between the long and short sides of the channel cross-section is also important for rapid heating. In a preferred embodiment, the long sides are at least six times as large as the short sides. Preferably, the long sides are at most eight times as large as the short sides.

In an optimized channel cross-section, the efficiency of the throughflow heater is further improved when the wall thickness of the inner sleeve is less than 0.5 mm. In an optimized production, the insulating core and the magnesium oxide are filled into an inner sleeve and a rolling step is carried out to compact the magnesium oxide. In a preferred embodiment, the inner sleeve has a wall thickness of less than 0.3 mm. This small wall thickness ensures a substantially instantaneous heat transfer from the heating layer into the liquid. Because the sleeve is completely filled inside by the insulating core and the compressed magnesium oxide, the necessary mechanical stability can be ensured even with a very small wall thickness.

To further reduce the heat transfer inertia and to reduce the unwanted outflow of heat through the channel walls, the wall thickness of the channel walls is chosen to be less than 0.4 mm, preferably less than 0.2 mm.

The rapid heating of the throughflow heater is further improved when the wall thickness of the outer sleeve is less than 0.8 mm, preferably less than 0.5 mm. This reduces the amount of heat absorbed by the outer sleeve during heating. In order that the outer sleeve can emit less heat, it is preferably further surrounded by a heat-insulating layer. Because the outer sleeve of throughflow heaters has a minimum distance of approx. 15 mm from the other parts of the units, the heat loss via heat conduction is already small. In order to reduce the radiated heat sufficiently, it is sufficient in many applications to arrange a foil on the outer surface of the outer sleeve.

A preferred embodiment prevents, even with an extremely thin layer of the heat-conducting material, disruptive voltage discharges from the electric heating element to a sleeve enclosing said element in that spacers ensure exact positioning of the insulating core in the inner sleeve. This exact positioning can neither be changed during production, nor during transport or heating processes. Even with small radial distances between the heating element held on the support surface of the insulating core and the inner sleeve, disruptive voltage discharges can be prevented because the minimum necessary radial distance is the same everywhere and is unable to change.

In this embodiment, the insulating core is arranged with the electric heating coil and optionally with an overheating protection device in the inner sleeve. At both axial ends of the insulating core, at least three regions with spacers are present in each case, which regions are distributed at substantially uniform intervals along the circumference and project radially over the support surface areas, and which spacers ensure a central positioning of the insulating core within the inner sleeve. The spacers may optionally be used as separate parts. Preferably, however, they are designed as radial projections of the insulating core. With the spacers, direct contact between the electric heating coil and the inner sleeve is prevented, even with a small thickness of the heating layer, or a minimum distance is ensured. It goes without saying that the spacers can have small dimensions in the circumferential direction, or else be formed by sections of annular projections or elements.

Preferably, the inner sleeve is formed of metal and sealed at a front side with a metallic end face in the manner of a cup. Between the inner sleeve and the insulating core with the electric heating coil, preferably a powdered, heat-conducting and electrically insulating material, such as magnesium oxide, is arranged. In order to achieve the desired high thermal conductivity, the powdery material is compacted. The volume of the filled inner sleeve can be reduced by means of a rolling or hammering process by radially narrowing and/or by pressing in the end face, so that the powdered material is compacted and the cavities are displaced. Because the forces acting on the insulating core and the spacers during rolling or hammering can be very great, the material of the insulating core and the spacer is chosen so that it withstands these forces.

In the case of the heat-conducting and electrically insulating material, a radial distance between the heating wire and the outer layer sleeve of less than 2 mm, in particular substantially 1.5 mm, is already sufficient to prevent electrical breakdown. According to the small distance, the mass of the heating layer is also very small, so that the heat generated by the heating wire passes with only a slight delay to the lead-through area and thus to the medium to be heated.

The cup-shaped inner sleeve is provided at the open end side with a first electrical connection contact and preferably with a final plug.

In a throughflow heater with an insulating core, which extends centrally along the longitudinal axis of the throughflow heater and has a lower thermal conductivity than the heat-conducting material of a heating layer adjacent on the outside to the insulating core, the overheating protection device and the size can be optimized. For this purpose, a cavity extending in the direction of the longitudinal axis is formed in the insulating core and arranged in this at least one overheating protection device. The jacket surface of the insulating core forms a support surface for the electric heating element and the heating element is also arranged in the area with the overheating protection device. Therefore, substantially the entire longitudinal extension of the throughflow heater can be used for the arrangement of the heating element, which allows a minimum length for each predetermined heating power.

If the extension of the throughflow heater in the direction of the longitudinal axis needs to be shorter, the size of the support surface and thus the surface area for the heating element can be kept at the same size with an increase in the cross-section of the insulating core, or be adapted to the desired heat output. Since the insulating core has a lower thermal conductivity than the heat-conducting material adjoining the outside of the heating element, the predominant portion of the heat generated quickly reaches the lead-through area and there into the fluid to be heated.

A heat flow from the heating element to the overheating protection device is reduced and delayed by the lower thermal conductivity of the insulating core compared to the heat-conducting material of the heating layer, which is referred to as a first effect. If, for instance, the generated heat cannot be released to a fluid to be heated for a short time, the temperature in the overheating protection device does not rise so high that the protection device is already triggered. Since the heating element is also arranged in the longitudinal section with the overheating protection device on the support surface extending around the overheating protection device, the overheating protection device cannot be cooled by an external disturbance below a triggering temperature, while at the same time the temperature of a section of the throughflow heater is already above a maximum permissible temperature, which is referred to as the second effect. These two effects ensure that the overheating protection device is not triggered unnecessarily or too late.

The overheating protection device arranged in the insulating core is connected on an electrical connection side to a first electrical connection contact arranged on one end side and on the other electrical connection side to a first contact of the electric heating element arranged on the insulating core. The arrangement of the heating element and the overheating protection device on or in the insulating core and the formation of the required electrical connections require little effort.

Overheating protection devices are also referred to as thermal fuses, and industrial safety standards guarantee safe operation by switching off the circuit when overheating. Depending on the application, a large selection of models is available to meet the various requirements of operating temperatures and rated currents. The security is further increased when two fuses are arranged in series.

The throughflow heating device according to the invention is compact, simple and fast-heating.

According to a preferred embodiment, the insulating core comprises silicate ceramics and/or oxide ceramics and/or non-oxide ceramics, wherein the ceramic material is shaped and compacted by sintering to the insulating core. The thermal conductivity of the insulating core is at most half as large as the thermal conductivity of the heat-conducting material. Preferably, the insulating core comprises ceramic material whose thermal conductivity is less than 5 Wm⁻¹K⁻¹, in particular less than 3 Wm⁻¹K⁻¹, and whose electrical resistance at 20° C. to 120° C. is preferably greater than 10⁶ Ωm, in particular greater than 10⁹ Ωm.

The insulating core can comprise, for example,

steatite having
thermal conductivity approx. 2 to 3 Wm⁻¹K⁻¹, electrical resistance approx. 10¹¹ Ωm,
   cordierite having
thermal conductivity approx. 1.5 to 2.5 Wm⁻¹K⁻¹, electrical resistance approx. 10¹⁰ Ωm, or
   aluminum titanate having
thermal conductivity approx. 1.5 to 3 Wm⁻¹K⁻¹, electrical resistance approx. 10¹¹ Ωm.

In order to ensure that the forces which also act on the insulating core when compressing the heat-conducting material do not generate any cracks in the insulating core or in the spacers, additives are optionally added to the material of the insulating core, which prevent the formation of cracks.

According to a further preferred embodiment, the outer surface, the transition surface, as well as the support surface are each substantially cylindrical shell-shaped with a circular cross-section, wherein the radius from the longitudinal axis to the support surface preferably extends at least over 70%, in particular at least 80%, of the radius of the longitudinal axis to the transition surface. As a result, a particularly compact design can be ensured.

According to a further preferred embodiment, the cavity of the insulating core has a cavity axis which extends at a distance from the central longitudinal axis of the insulating core, so that the smallest distance between the at least one overheating protection device arranged in the cavity and the nearest region of the electric heating element corresponds to a predetermined distance. The predetermined distance can be selected depending on the thermal conductivities of the insulating core and the heat-conducting material so that the temperature development in the overheating protection device takes place with a desired inertia or damping.

According to a further preferred embodiment, a second electrical connection contact is also arranged on the face end with the first electrical connection contact, which is connected to a second contact of the electric heating element, wherein in the insulating core a bore extending parallel to the longitudinal axis is formed, through which an electrical connection is guided from a contact of the heating element against one of the two electrical connection contacts. The arrangement of these connection contacts on a face end facilitates the installation of the throughflow heater in a device.

According to a further preferred embodiment, the heating element is formed by a resistance wire, which is wound as an electric heating coil from one to the other end face of the insulating core on the support surface of the insulating core and the insulating core is electrically insulating due to a sufficiently high electrical resistance. This design can be easily made.

According to a preferred embodiment, the heat-conducting material has a thermal conductivity above 5 Wm⁻¹K⁻¹, and the electrical resistance of the heat-conducting material at 20° C. to 120° C. is greater than 10⁶ Sam, preferably greater than 10⁹ Sam. The heat-conducting material between the electric heating element and the transition surface preferably has a thickness of not more than 4 mm or optionally of not more than 2 mm, so that the heat emitted by the heating element reaches the lead-through area without disturbing time delay and the electric heating element is electrically isolated.

The heat-conducting material can comprise, for example,

magnesium oxide having
thermal conductivity approx. 6 to 10 Wm⁻¹K⁻¹, electrical resistance approx. 10¹¹ Ωm,
   aluminum oxide having
thermal conductivity approx. 10 to 30 Wm⁻¹K⁻¹, electrical resistance approx. 10¹² Ωm, or
   aluminum silicate (65-80% Al₂O₃) having
thermal conductivity approx. 6 to 15 Wm⁻¹K⁻¹, electrical resistance approx. 10¹¹ Ωm.

There is also ceramic material with even greater thermal conductivity and a high electrical resistance, such as non-oxide ceramic such as aluminum nitride with a thermal conductivity of 100 to 180 Wm⁻¹K⁻¹ and an electrical resistance of about 10¹² Ωm and alunite with a thermal conductivity of approx. 180 Wm⁻¹K⁻¹ and an electrical resistance of about 10¹¹ Ωm. Another example of oxide ceramics is Al₂ZrO₂ with a thermal conductivity of approx. 20 Wm⁻¹K⁻¹ and an electrical resistance of about 10⁹ Ωm.

According to a preferred embodiment, the outer sleeve is connected at least at one end face tightly to the inner sleeve. Between the inner and the outer sleeve at least one channel is formed, which extends between two connections. This channel is preferably coiled around the longitudinal axis. At least one coiled guide wall is present for forming the channel. The guide wall extends from the outer surface against the transition surface and is formed on the outer sleeve or on the inner sleeve or inserted as an intermediate part between the inner and the outer sleeve. The guide wall need only ensure that the large proportion of the medium flowing through the channel flows completely along the helical shape. Even if the guide wall does not adjoin completely tightly to both sleeves, it is still possible to ensure that the channel continues to flow essentially through the helical shape.

The incorporation of the channel in the inside or in the outside of a sleeve can also be carried out before the formation of the sleeve shape. For this purpose, for example, a blank of a sheet can be pressed with a press into a shaped part so that on one side segments of the channel wall project from the sheet. This sheet with protruding segments of the channel wall can then be formed into a tubular shape and can be closed at adjoining side lines with a longitudinal seam, in particular a laser seam, to form a tube. The segments of the channel wall then adjoin each other so that a helical channel wall is provided.

In this case, the longitudinal seam can also be formed at the channel wall. The channel wall does not necessarily have to be continuous because it only has to ensure that the water flows essentially along the channel through the throughflow heater. Embodiments are also possible in which the channel wall is interrupted in the longitudinal seam, so that the side lines of the sheet metal blank to be joined together run along straight lines. As a result, the formation of the longitudinal seam is simplified.

Adjoining the channel, an inlet for a liquid to be heated is formed at one end of the channel and an outlet for the latter at the other end. The inlet and the outlet preferably lead in the radial direction through the outer sleeve.

In order to supply the generated heat substantially completely to the medium or the liquid in the channel, in a further preferred embodiment, the helically extending guide walls are formed as narrow as possible, so that in a longitudinal section of the cylindrical throughflow heater, the predominant length fraction is occupied preferably more than 80%, in particular more than 90%, by the adjacent channel sections in the axial direction. When the channel is filled with a medium to be heated, the majority of the heat flowing radially outward from the inner layer goes directly into the medium. Even from the narrow channel walls, a large proportion of the incoming heat goes into the medium to be heated, so that only a very small proportion of the heat does not enter the medium.

The dimensioning of the throughflow heater, in particular the radial and axial extensions of the outer layer and the inner layer, and the heating power of the heating coil can be easily adapted to the particular application. The throughflow heater according to the invention can be used advantageously wherever predetermined flow rates of a medium must be provided without heat storage and with short reaction times at a predetermined temperature.

The throughflow heater is used for heating water, wherein the electrical supply of the electric heating element is controlled by a controller which at least determines whether the heating element is to be electrically powered or whether no heat is to be generated.

Preferably, the respective heating of the water to a selectable consumption temperature is adaptable, in particular with an adjustment of heating power and at least one temperature measurement and/or a flow rate measurement.

For coffee machines, the throughflow heater can be designed so that, after a delay of less than 7 seconds, it can continuously supply water at a temperature of over 90° C., for example at least 94° C., wherein the inlet temperature of the water is at approx. 20° C. and the water volume located at the same time in the channel is less than 4000 mm³, preferably 2000 to 3000 mm³, in particular about 2500 mm³ or 2.5 ml. If 2.5 ml of water is accommodated in the channel, water must be provided for 1 dl of coffee within the scope of 40 times the channel volume. After starting the water heating, the water in the duct is first heated to the desired temperature during a short heating time. An electrical heat output of 1750 watts or less is enough to heat the water in the channel to the desired temperature within 7 seconds. Subsequently, the water is conveyed with the desired flow rate through the throughflow heater and heated during flow to the desired temperature. The throughflow heater according to the invention can then ensure the desired outflow rate of water at the desired temperature with a reduced electrical power.

The small channel volume is very advantageous because then already such a large flow rate is used for a minimum desired flow rate that lime is deposited less or deposited particles are entrained. In addition, it could be shown with experiments that the desired temperature can be maintained extremely accurately. The deviations from the desired temperature are below 1.5° C., in particular at a maximum of 1° C. This accuracy and provision with little waiting time is very advantageous, for example, in coffee machines.

It is understood that the channel volume and the heating power can be adapted to the respective requirements.

Other beverage machines or laboratory equipment may have different requirements for temperature and flow capacity. The respective requirements with the corresponding specifications for overheating protection can be easily met with the corresponding design of the throughflow heater according to the invention.

Also for applications with large flow rates but lower temperatures, such as a shower toilet, where 1l of water is required per minute at 37° C., the throughflow heaters according to the invention can be used with appropriate design.

In order for the throughflow heater to be able to adapt its power or the heating of the fluid to a desired fluid outlet temperature and in particular to a respective fluid flow rate, it is fed by means of a controller. The controller must receive at least one on-off signal that determines whether the heating wire should be electrically energized or whether no heat should be generated. If the heating wire is electrically powered, it can achieve a heating output according to the flowing current strength. If the temperature of the heated fluid is to be selectable and this also for different flow rates, the controller will receive in addition to the on-off signal at least one further signal from a temperature sensor at the end of the throughflow heater and/or from a flow sensor and/or from a temperature sensor received at the inlet of the throughflow heater and take this into account when setting the heating power.

Due to the high efficiency and the rapid provision of hot water, the throughflow heater according to the invention is also suitable for heating hot water obtained via faucets or shower heads. Because the powerful throughflow heater can be manufactured inexpensively, it is possible to equip all consumption points with a throughflow heater. In this case, the maximum heating power can be adjusted to the maximum hot water consumption (max. temperature, max. flow rate) of a consumption point, wherein for different consumption points such as bathroom or kitchen, the different demands on the maximum water temperature and the maximum flow can be considered.

The respective heating of the water can be adapted to the consumption temperature selected by the consumer. If the electrical supply of the throughflow heater is connected via a control connection to a setting device of the fitting of the point of consumption, the heating power can be adjusted exactly to the selected position of the setting device.

Optionally, a temperature measurement at the discharge of the throughflow heater and/or a flow rate measurement are used in the adjustment of the heating power. The throughflow heater according to the invention allows service water to be provided directly at a very precisely predetermined temperature. If the heating of the service water is based on cold water, then it is possible to dispense with a central hot water storage tank and the parallel laying of hot and cold water pipes. It can be assumed that the cost of the throughflow heaters required at the consumption points is smaller than the cost of the hot water storage tank and the hot water pipes.

The overheating protection device ensures that no superheated water is discharged and that the material in contact with it is not heated enough to damage it or cause a fire.

In a preferred embodiment, the outer sleeve is sealed at one end face with a hood-shaped cover. This cover comprises one of the two connections, which cover preferably extends in the direction of the longitudinal axis and is arranged in particular in the center of the cover. This embodiment is particularly advantageous when the throughflow heater is to generate steam. Tests have shown that in the production of steam, lime deposits are only made at the end of the channel at the exit into a connection radially leading away from the channel. The cover allows escape of the steam and of course also of hot water in the direction of the longitudinal axis, or without deflection in a radial direction to the longitudinal axis. The cover can connect the lead-through area, or the channel between the inner sleeve and the outer sleeve, via deflection areas with sufficiently large radii of curvature to the connection. As a result, the deposition of line is minimized in the production of hot water and steam.

In a further advantageous embodiment, the throughflow heater comprises a spring-shaped intermediate part for channel formation, which is inserted between the inner and the outer sleeve. In order to ensure that the intermediate part is held in a desired position in the direction of the longitudinal axis and optionally in the circumferential direction, the outer sleeve and/or the hood-shaped cover is deformed somewhat radially inwards at at least one point, so that the intermediate part is tightly clamped in this deformation. If necessary, the hood-shaped cover also has an alignment stop, preferably a depression. During assembly, the alignment stop is engaged with a corresponding alignment element.

In order to provide hot water or steam quickly and with accurate temperature, the switching on and off of high electric heating power is necessary. Such high power changes affecting the electrical network can cause disturbances in the network. To prevent such interference, the heating element is divided into at least two sections according to a further advantageous design. The insulating core preferably comprises two partial regions for sections of the heating element on the support surface formed on the jacket surface. Both sections each comprise a wound electrical resistance wire and electrical leads feeding said wire. On the face end of the throughflow heater with the electrical connection contacts, at least three terminal contacts are thus formed, namely the supply terminals for the two sections and the neutral. The heating wires of both sections are each connected to the corresponding supply terminal and the neutral conductor. For this purpose, corresponding bores for the lines are formed in the insulating core.

In a throughflow heater for coffee machines, it is expedient if one section can be operated for example with 1300 watts and the other with 650 watts. The heating power can then be changed by successively performed activation and deactivation of the two sections with smaller individual power changes. As a result, the desired temperature can be adjusted very accurately without interference.

Further details of the invention will become apparent with reference to the following description of an embodiment schematically illustrated in the drawings, wherein:

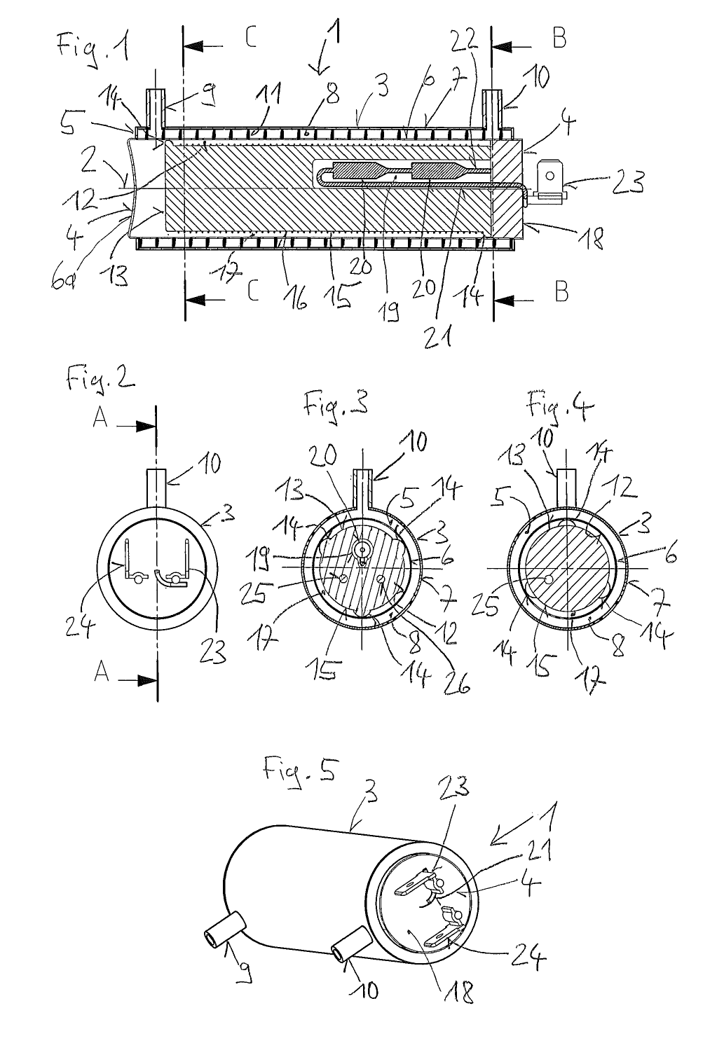

FIG. 1 shows a longitudinal section through a throughflow heater (AA according to FIG. 2);

FIG. 2 shows a view of the end face with the electrical terminal contacts;

FIG. 3 shows a cross-section BB according to FIG. 1;

FIG. 4 shows a cross-section CC according to FIG. 1;

FIG. 5 shows a perspective view of the throughflow heater;

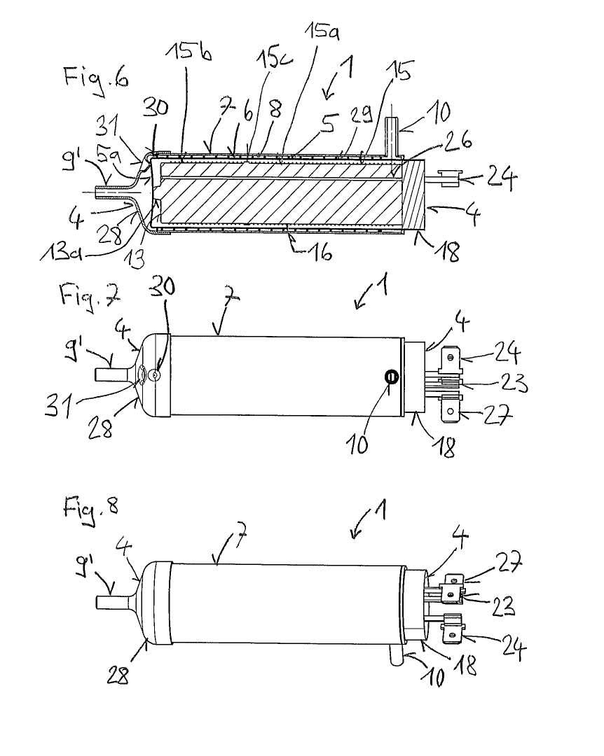

FIG. 6 shows a longitudinal section through a throughflow heater with a hood-shaped cover;

FIG. 7 shows a side view of the throughflow heater according to FIG. 6; and

FIG. 8 shows a perspective view of the throughflow heater according to FIG. 6.

FIGS. 1 to 5 show a throughflow heater 1 with an outer surface 3 extending around a longitudinal axis 2 and two end faces 4 extending transversely to the longitudinal axis 2 and away from each other. A lead-through area 5 for a fluid to be heated adjoins the outer surface 3 on the inside. In the illustrated embodiment, the lead-through area 5 comprises an inner sleeve 6 and an outer sleeve 7, wherein these two sleeves 6, 7 are tightly connected to each other at the two end faces 4. Between the inner and the outer sleeve 6, 7, a channel 8 is formed, which extends between two terminals 9 and 10 wound around the longitudinal axis 2 and comprises in addition at least one coiled guide wall 11. The coiled guide wall 11 extends in longitudinal section and in cross-section in a radial direction from an area at the outer surface 3 against a region at a transition surface 12 on the inner side of the inner sleeve 6 directed against the longitudinal axis 2.

In the illustrated embodiment, the coiled guide wall 11 is formed on the outer sleeve, or the channel 8 is incorporated into the outer sleeve 7 so that the guide wall 11 projects from the outer surface 3 against the longitudinal axis 2. It would also be possible that the guide wall 11 is formed on the outer side of the inner sleeve 6 or inserted as an intermediate part between the inner and the outer sleeve 6, 7.

In the inner sleeve 6, or within the transition surface 12, an insulating core 13 is arranged, whose jacket surface forms a support surface 15 for a heating element 16 in the form of an electrical resistance wire wound on the support surface 15. The heating element 16 or the resistance wire wound onto the support surface 14 from one face end of the insulating core 13 to the other is thus an electric heating coil. The heating element 16 forms a heating layer 17 together with the heat-conducting material arranged between the support surface 15 and the transition surface 12.

For optimal positioning or centering, the insulating core 13 comprises at both axial ends in each case at least three spacers 14 protruding radially beyond the support surface at substantially uniform intervals along the circumference, which ensure a distance between the support surface 15 and the inner sleeve. Even with a small thickness of the heating layer 17, direct contact between the electric heating element and the inner sleeve is prevented. Both the insulating core 13 and also the heat-conducting material of the heating layer 17 have a sufficiently high electrical resistance, so that the supplied current flows only through the heating wire.

In the illustrated embodiment, the inner sleeve 6 is formed of metal and closed off in a cup-shaped manner at an end face 4 with a metallic front surface 6a. Between the inner sleeve 6 and the insulating core 13, powdery heat-conducting and electrically insulating material, such as magnesium oxide, is filled. In order to achieve the desired high thermal conductivity, the powdery material is compacted. The volume of the filled inner sleeve can be reduced by means of a rolling process by radially constricting and/or by pressing in the front surface 6a, so that the powdery material is compressed and the cavities are displaced. At the of the metallic front surface 6a facing away from end face 4, a final plug 18 is attached.

The insulating core 13 comprises a cavity 19 extending in the direction of the longitudinal axis 2. In this cavity 19, two overheating protection devices 20 are arranged in series in a section of the longitudinal axis 2 with a heating element 16 arranged on the outside of the support surface 15. A first electrical connection side of these overheating protection devices is connected via a first line 21 to a first electrical connection contact 23 arranged on the end face 4 with the plug 18. A second electrical connection side of the overheating protection devices 20 is connected via a second line 22 at the plug 18 to a first contact of the electric heating element 16 (not shown).

On the end face 4 with the first electrical connection contact 23, a second electrical connection contact 24 is arranged, which is connected to a second contact of the electric heating element 16. In order to lead an electrical line from the second electrical connection contact 24 to the second contact of the electric heating element 16 at the insulating core end, which faces the front surface 6a, a bore 25 extending parallel to the longitudinal axis 2 is formed in the insulating core 13. This bore 25 can also be used for fixing the first electrical connection contact 23. For fixing the second electrical connection contact 24, the insulating core 13 comprises at the end face 4 with the plug 18 an insertion opening 26.

In the operating state, the heat generated by the heating element 16 passes through the thin heating layer 17 with the heat-conducting material with only insignificant delay and reduction to the lead-through area 5. In the insulating core 13 with the lower thermal conductivity, only a small proportion of heat flows. If, however, due to a disturbance, the heat in the lead-through area 5 is not absorbed by the fluid to be heated, heat is increasingly also transferred to the insulating core 13 and thus to the overheating protection devices 20. In order to improve the heat conduction from the insulating core to the overheating protection devices 20, heat-conducting material is preferably introduced into the cavity 19 around the overheating protection devices 20.

The cavity 19 of the insulating core 13 has a cavity axis, which extends at a distance from the central longitudinal axis 2 of the insulating core 13, so that the smallest distance between overheating protection devices 20 arranged in the cavity 19 and the nearest region of the electric heating element 16 corresponds to a predetermined distance. With the choice of this distance, the delay or damping of the heat flow to the overheating protection device 20 can be influenced. The sensitivity of the overheat protection 20 is also selected according to the selected distance.

In the illustrated embodiment, the outer surface 3, the transition surface 12, and the support surface 15 are each formed substantially cylinder-jacket-shaped with a circular cross-section. The radius from the longitudinal axis 2 to the support surface 15 extends at least over 70%, in particular at least over 80%, of the radius from the longitudinal axis 2 to the transition surface 12.

FIGS. 6 to 8 show a throughflow heater 1 with a hood-shaped cover 28. The outer sleeve 7 is tightly sealed at one end face 4 with the hood-shaped cover 28. This cover 28 comprises the connection 9′, which extends in the direction of the longitudinal axis and is formed in the center of the cover 28. The cover 28 connects the lead-through area 5 or the channel 8 between the inner sleeve 6 and the outer sleeve 7 via deflection regions with sufficiently large radii of curvature to the connection 9′.

For channel formation, the throughflow heater 1 comprises a spring-shaped intermediate part 29 which is inserted between the inner and the outer sleeve 6, 7. In order to ensure that the intermediate part 29 is held in a desired position in the direction of the longitudinal axis and optionally in the circumferential direction, at least one dent 30 is formed after the desired positioning of the intermediate part 29 on the dome-shaped cover 28, so that the intermediate part 29 is tightly clamped. The hood-shaped cover 28 also has an alignment stop in the form of a recess 31. During assembly, the recess 31 is brought into engagement with a corresponding alignment element.

FIGS. 6 to 8 show an embodiment in which the heating element 16 is divided into two sections. The insulating core 13 comprises two partial areas 15a and 15b on the jacket surface formed on the support surface 15, which are separated from each other by a radial elevation 15c. On both partial areas 15a and 15b, an electrical resistance wire is wound in each case. Both wound resistance wires are each connected via feeding electrical connection lines to a pair of connection contacts 23, 24 or 27, wherein the connection contact 27 is provided for the second section. The electrical connection lines from the ends of the resistance wires to the three connection contacts 23, 24 and 27 are guided in corresponding bores 25, 26 through the insulating core 13. An electrical connection line is guided at the end facing away from the connection contacts 23, 24 and 27 of the insulating core 13 to the bore 26. In order to ensure that this electrical connection line is unable to come into contact with the metallic end face 5a of the inner sleeve 5, the insulating core 13 comprises a projection 13a projecting centrally against this end face. The insulating core 13 can thus be inserted as far into the inner sleeve 5 when assembling the throughflow heater 1 until the projection 13a is rests thereon. This ensures the correct positioning.

1. The throughflow heater having an outer surface extending around a longitudinal axis and two end faces facing away from each other and extending transversely to the longitudinal axis, a lead-through area adjoining the outer surface on the inside for a fluid to be heated, a heating layer adjoining the lead-through area at a transition surface on the inside, said heating layer comprising an electric heating element and heat-conducting material, an insulating core extending centrally along the longitudinal axis and externally forming a support surface for the electric heating element and the heat-conducting material, wherein the thermal conductivity of the insulating core is lower than that of the heat-conducting material, the lead-through area comprises an inner sleeve at the transition surface, an outer sleeve at the outer surface, and between the inner and the outer sleeve at least one channel which extends between two terminals and around the longitudinal axis in a coiled manner and comprises in addition at least one coiled guide wall which extends from the outer surface against the transition surface and determines a rectangular channel cross-section with two long sides at the sleeves and two short sides at the guide wall, wherein in the cross-section of the coiled channel the length of the short, radially extending sides is smaller than 1 mm, preferably in the range of 0.8 mm to 0.4 mm, and especially the long sides are at least six times as large as the short sides.

2. A throughflow heater according to claim 1, wherein spacers which protrude radially over the support surface are provided in each case at both axial ends of the insulating core in at least three areas which are substantially uniformly distributed at regular intervals along the circumference, which ensure a central positioning of the insulating core within the inner sleeve and even at a small thickness of the heating layer prevent a direct contact between the electric heating element and the inner sleeve.

3. A throughflow heater according to one of the claim 1, wherein the insulating core comprises silicate ceramics and/or oxide ceramics and/or non-oxide ceramics, wherein the ceramic material is shaped and compacted by sintering to the insulating core, the thermal conductivity of the insulating core is at most half as large as the thermal conductivity of the heat-conducting material, the insulating core preferably comprises ceramic material whose thermal conductivity is less than 5 Wm⁻¹K⁻¹, in particular less than 3 Wm⁻¹K⁻¹, and whose electrical resistance at 20° C. to 120° C. is preferably greater than 10⁶ Ωm, in particular greater than 10⁹ Ωm.

4. A throughflow heater according to claim 1, wherein the outer surface, the transition surface, and the support surface are each formed in a substantially cylindrical shell-shaped manner with a circular cross-section, wherein the radius extends from the longitudinal axis to the support surface preferably at least over 70%, in particular at least over 80%, of the radius from the longitudinal axis to the transition surface.

5. A throughflow heater according to claim 1, wherein the insulating core comprises a cavity extending in the direction of the longitudinal axis and that in this cavity-, in a section of the longitudinal axis with a heating element arranged on the outside on the support surface, at least one overheating protection device is arranged, which on an electrical connection side is connected to a first electrical connection contact arranged at one end face and on the other electrical connection side is connected to a first contact of the electric heating element-, wherein preferably the cavity of the insulating core has a cavity axis which extends at a distance from the central longitudinal axis of the insulating core, so that the smallest distance between the at least one overheating protection device arranged in the cavity and the nearest region of the electric heating element corresponds to a predetermined distance.

6. A throughflow heater according to claim 1, wherein a second electrical connection contact is also arranged on the end face with the first electrical connection contact, which second electrical connection contact is connected to a second contact of the electric heating element, wherein in the insulating core, a bore extending parallel to the longitudinal axis is formed, through which an electrical connection of a contact of the heating element is guided against one of the two electrical connection contacts.

7. A throughflow heater according to claim 1, wherein the heating element is formed by a resistance wire which is wound as an electric heating coil from one end face to the other end face of the insulating core onto the support surface of the insulating core and the insulating core is electrically insulating due to a sufficiently high electrical resistance.

8. A throughflow heater according to claim 1, wherein the inner sleeve is closed off at one end face with a front surface in a cup-shaped manner and comprises a final plug on the end face facing away therefrom with the first electrical connection contact.

9. A throughflow heater according to claim 1, wherein the heat-conducting material is filled and pressed in a powdery manner between the inner sleeve and the insulating core, the heat-conducting material has a thermal conductivity above 5 Wm⁻¹K⁻¹, and the electrical resistance of the heat-conducting material at 20° C. to 120° C. is greater than 10⁶ Ωm, preferably greater than 10⁹ Ωm, and especially the heat-conducting material between the electric heating element and the transition surface preferably has a thickness of not more than 4 mm or optionally of not more than 2 mm, so that the heat emitted by the heating element reaches the lead-through area without disturbing time delay and the electric heating element is electrically insulated.

10. A throughflow heater according to claim 1, wherein the coiled guide wall is formed on the outer sleeve or optionally on the inner sleeve or preferably inserted as an intermediate part between the inner and the outer sleeve.

11. A throughflow heater according to claim 1, wherein the outer sleeve is tightly connected at at least one end face to the inner sleeve.

12. A throughflow heater according to claim 1, wherein the outer sleeve is tightly connected at one end face to a hood-shaped cover and the cover comprises one of the two terminals, which preferably extends in the direction of the longitudinal axis and is arranged in particular in the center of the cover.

13. A throughflow heater according to claim 1, wherein at least two sections of the heating element are arranged on the support surface of the insulating core, which each comprise a wound electrical resistance wire and electrical connecting leads feeding said wire.

14. The use of a throughflow heater according to one of the preceding claims for heating water, wherein the electrical supply of the electric heating element is controlled by a controller which at least determines whether the heating element is to be electrically powered or whether no heat should be generated.

15. The use according to claim 14, wherein the throughflow heater makes the respective heating of the water adaptable to a selectable consumption temperature, in particular with an adjustment of the heating power and at least one temperature measurement and/or flow rate measurement.
